(19) United States
(12) Patent Application Publication
(10) Pub. No.: US 2013/0273784 A1
(43) Pub. Date: Oct. 17, 2013

(54) ELECTRICAL CONNECTOR

(71) Applicants: TERRANCE F. LITTLE, Fullerton, CA (US); AN-JEN YANG, Irvine, CA (US); DUONG PHAN, City of Westminister, CA (US); STEPHEN SEDIO, Valley Center, CA (US); YUNG-JYH LING, Portland, OR (US)

(72) Inventors: TERRANCE F. LITTLE, Fullerton, CA (US); AN-JEN YANG, Irvine, CA (US); DUONG PHAN, City of Westminister, CA (US); STEPHEN SEDIO, Valley Center, CA (US); YUNG-JYH LING, Portland, OR (US)

(21) Appl. No.: 13/738,950

(22) Filed: Jan. 10, 2013

Related U.S. Application Data
(60) Provisional application No. 61/624,420, filed on Apr. 16, 2012.

(51) Int. Cl. H01R 13/60

(52) U.S. Cl. CPC H01R 13/60
USPC 439/660

(57) ABSTRACT

An electrical connector (100) includes an insulative housing (1), a plurality of contacts (2), a metal shell (3) enclosing the housing (1) to form a mating opening (110) and a mounting plate (4) covering the metal shell (3). The housing (1) has a base portion (10) having a retaining groove (121) and a tongue (11) extending forwardly from the base portion (10). The mounting plate (4) includes a pressing plate, a vertical tab (431) extending from a rear edge of the pressing plate (41) and fastened in the retaining groove (121) and at least a pressing arm (451) extending downwardly through the metal shell into the mating opening (110). When the electrical connector (100) mates with a mating connector (200), the pressing plate (41) is upwardly forced and the mounting plate deflects upwardly and brings the pressing arm (451) to leave the mating opening (110).

This application claims benefits of the copending application 61/624,420 filed Apr. 16, 2012.

### BACKGROUND OF THE INVENTION

1. Field of the Invention

The present invention generally relates to an electrical connector and more particularly to an electrical connector having a mounting plate to prevent a mating connector from mis-inserting.

2. Description of Related Art

The USB connector as an interface, is popularly used in the industry. FIG. 1 shows the Micro B receptacle 10 defines chamfered structures 12 thereof to conform with the Micro B plug 20 which is also equipped with the chamfered structures 22 so as to prevent an upside down mis-mating as shown in FIG. 2. Anyhow, as shown in FIG. 3 the Micro AB receptacle 30 defines a rectangular interface without chamfered structure thereof for being matable with not only Micro B plug 20 but also Micro A plug (not shown) which defines a rectangular interface. Under such situation, the Micro B plug 20 may be mistakenly upside down inserted into the Micro AB receptacle 30 as shown in FIG. 4 wherein the inner mating tongue of the Micro AB receptacle may be damaged by the upside-down mis-mating Micro B plug 20.

Chinese patent No. CN202142713U discloses an electrical connector including an insulative housing, a plurality of contacts retained in the insulative housing, a metal shell covering the insulative housing and a mounting plate covering upon a top surface of the metal shell along an upper-to-down direction. The insulative housing includes a base portion and a tongue extending forwardly from the base portion. The insulative housing is assembled into the metal shell along a back-to-front direction. The mounting plate includes a pressing plate covering upon the metal shell and two extending plates extending downwardly and resisting two sides of the metal shell. The mounting plate can improve the strength of the metal shell, but can not offer another affect.

Other objects, advantages and novel features of the present invention will become more apparent from the following detailed description of the present embodiment when taken in conjunction with the accompanying drawings.

### SUMMARY OF THE INVENTION

The present invention provides an electrical connector includes an insulative housing, a plurality of contacts retained in the housing, a metal shell enclosing the housing to form a mating opening and a mounting plate covering the metal shell. The housing has a base portion having a retaining groove depressing downwardly from a top surface thereof and a tongue extending forwardly from the base portion. The mounting plate includes a tab inserting into the retaining groove and at least a pressing arm extending downwardly into the mating opening. Usually, a mating connector includes a locking contact extending upwardly from one surface of thereof. The mating connector inserts into the mating opening must be pecks the pressing arm upwardly firstly to prevent the mating connector from inserting mismatch.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view showing an electrical USB Micro B receptacle connector confronting an upside-down inserted Micro B plug in a conventional way.

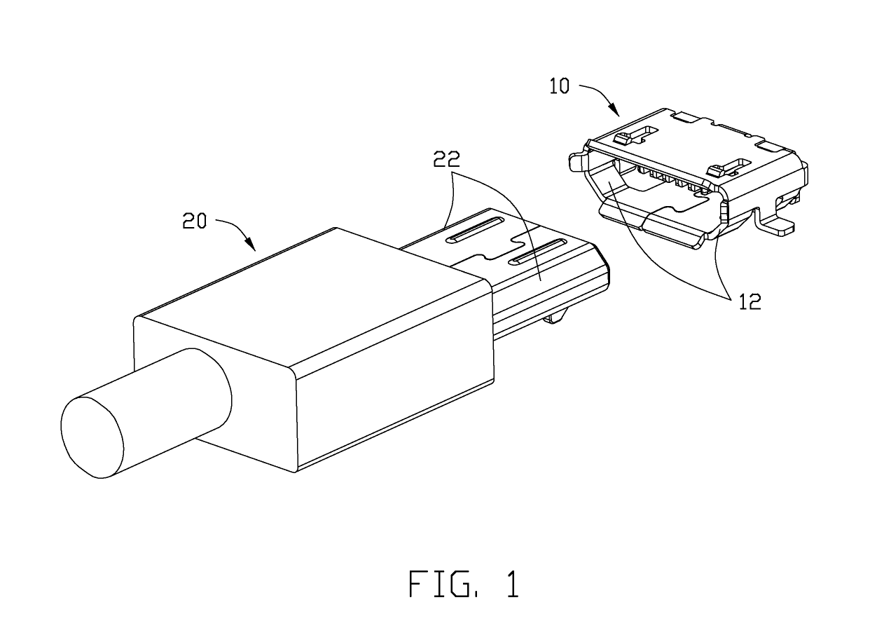

FIG. 2 is a perspective view showing the upside-down inserted Micro B plug is stopped by the chamfered structures of the Micro B receptacle of FIG. 1.

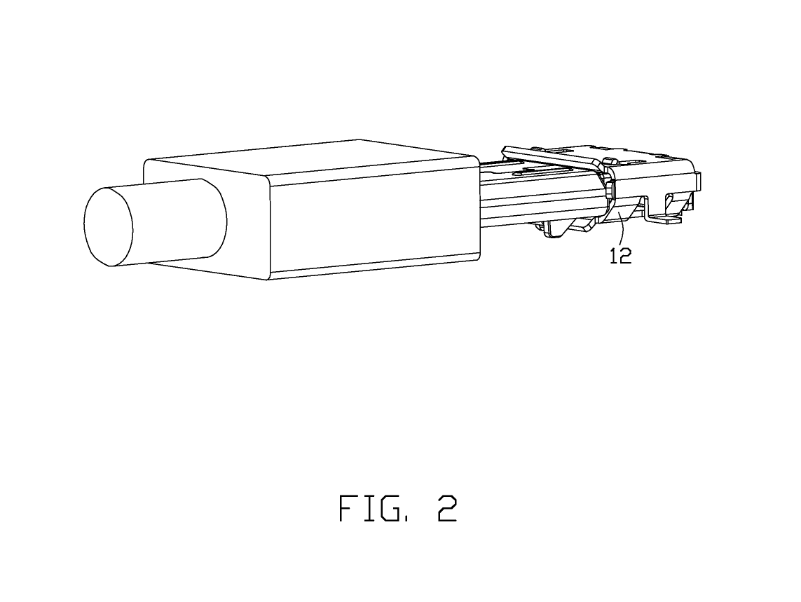

FIG. 3 is a perspective view showing the Micro AB receptacle connector confronting an upside-down inserted Micro B plug in a conventional way.

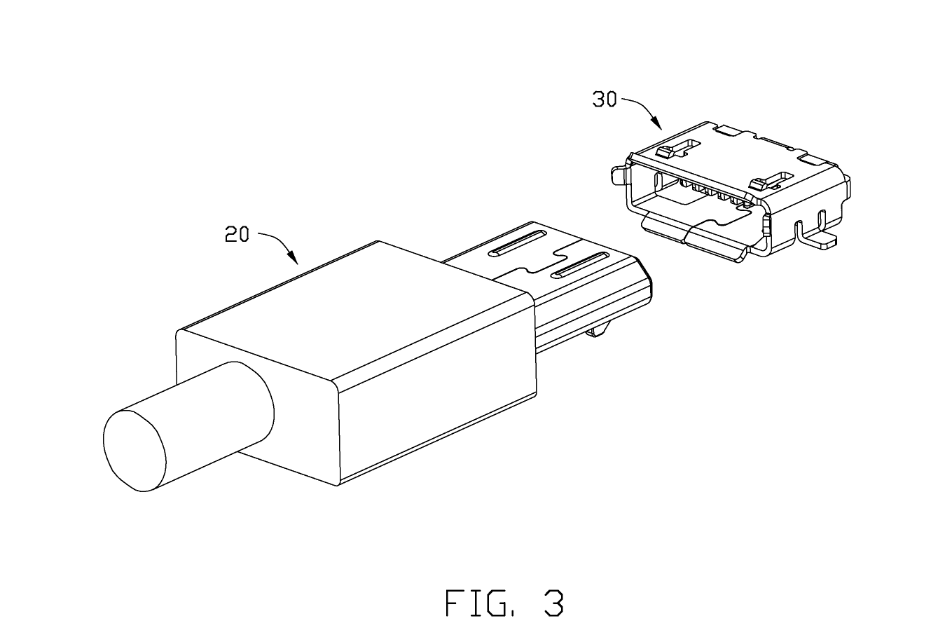

FIG. 4 is a perspective view showing the upside inserted Micro B plug may mistakenly enter the mating port of the Micro AB receptacle of FIG. 3.

FIG. 5 is an assembled, perspective view of an electrical connector according to a preferred embodiment of the present invention;

FIG. 6 is another assembled, perspective view of the electrical connector as shown in FIG. 5 taken from a back side.

FIG. 7 is a partially exploded perspective view of the electrical connector.

FIG. 8 is a further exploded perspective view of the electrical connector as shown in FIG. 7;

FIG. 9 is similar with FIG. 7, while taken from a different aspect;

FIG. 10 is a perspective view of the electrical connector and a mating connector;

FIG. 11 is a cross-sectional view of the mating connector being to insert into the electrical connector as shown in FIG. 10;

FIG. 12 is a cross-sectional view of the mating connector further inserting into the electrical connector from a position as shown in FIG. 10;

FIG. 13 is a cross-sectional view of the mating connector inserting into the electrical connector in a wrong direction.

### DETAILED DESCRIPTION OF THE INVENTION

In the following description, numerous specific details are set forth to provide a thorough understanding of the present invention. However, it will be obvious to those skilled in the art that the present invention may be practiced without such specific details.

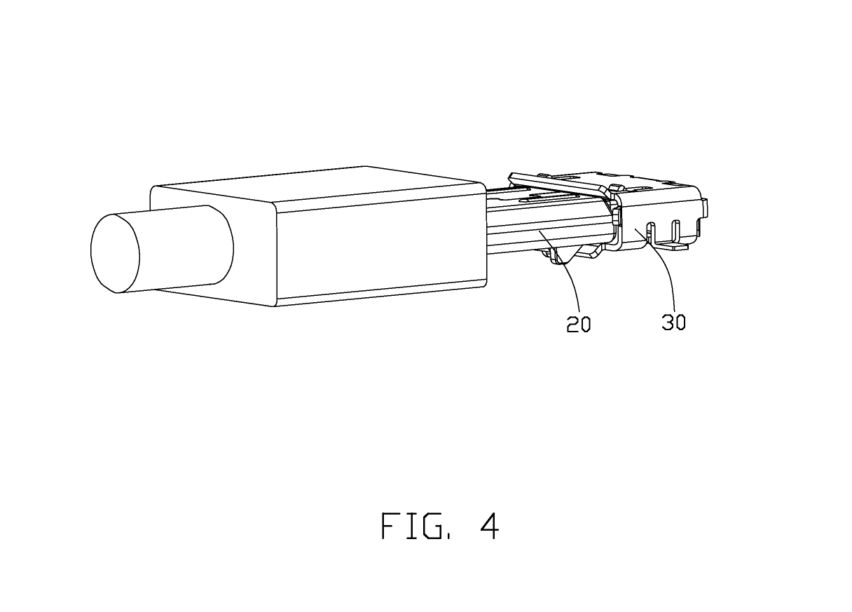

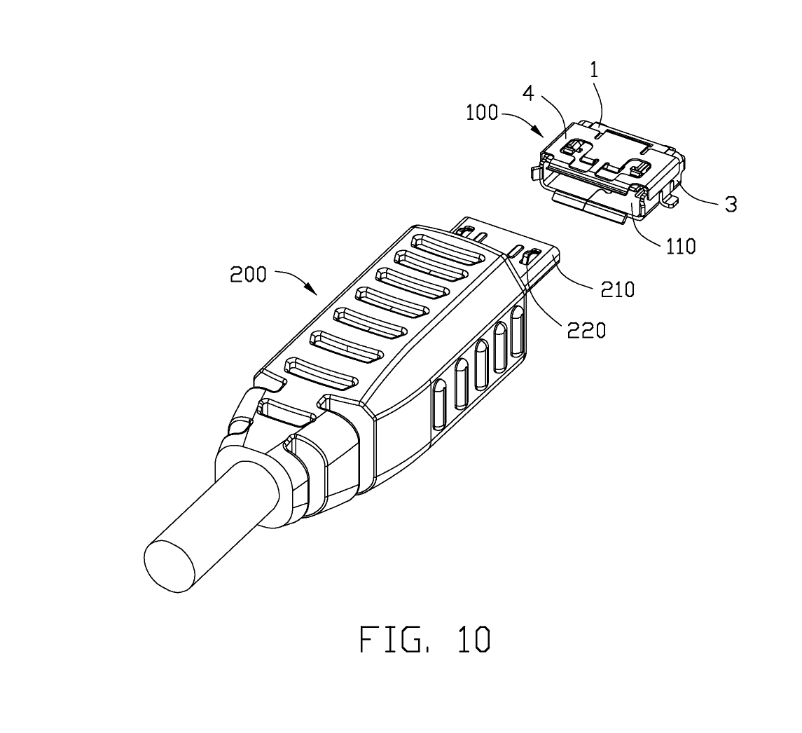

Referring to FIGS. 4-10, an electrical connector 100 according to an embodiment of the present invention is disclosed. The electrical connector 100 can be soldered to a circuit board (not shown) for being adapted for mating with a mating connector 200. The electrical connector 100 includes an insulative housing 1, a plurality of contacts 2 received in the insulative housing 1, a metal shell 3 enclosing the insulative housing 1 and a mounting plate 4 covering the metal shell 3.

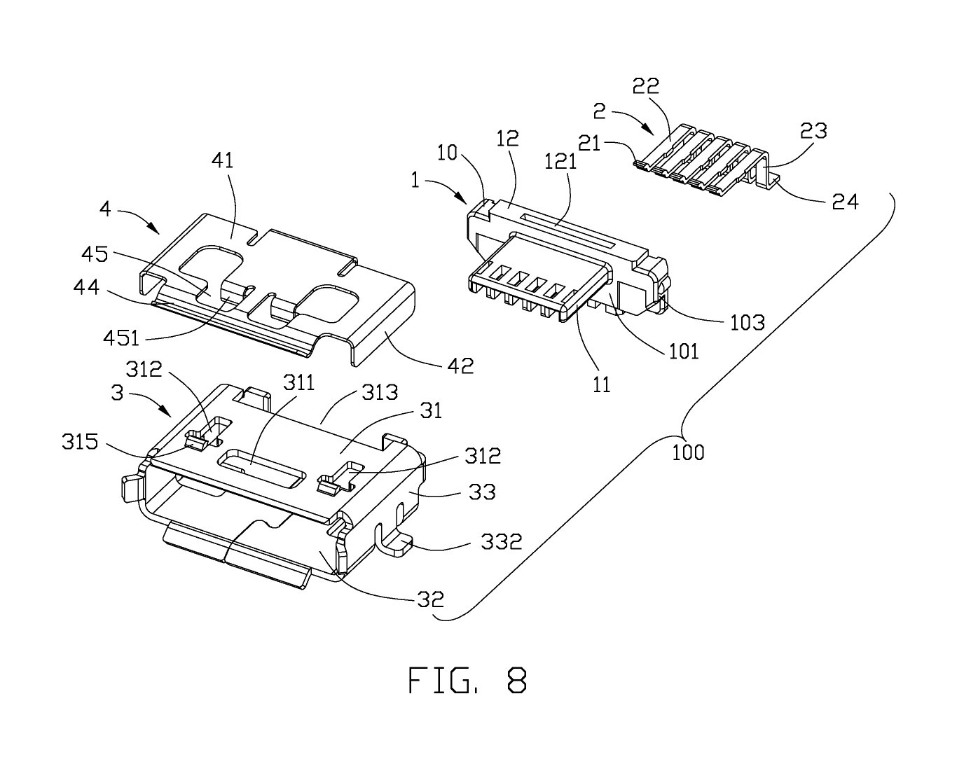

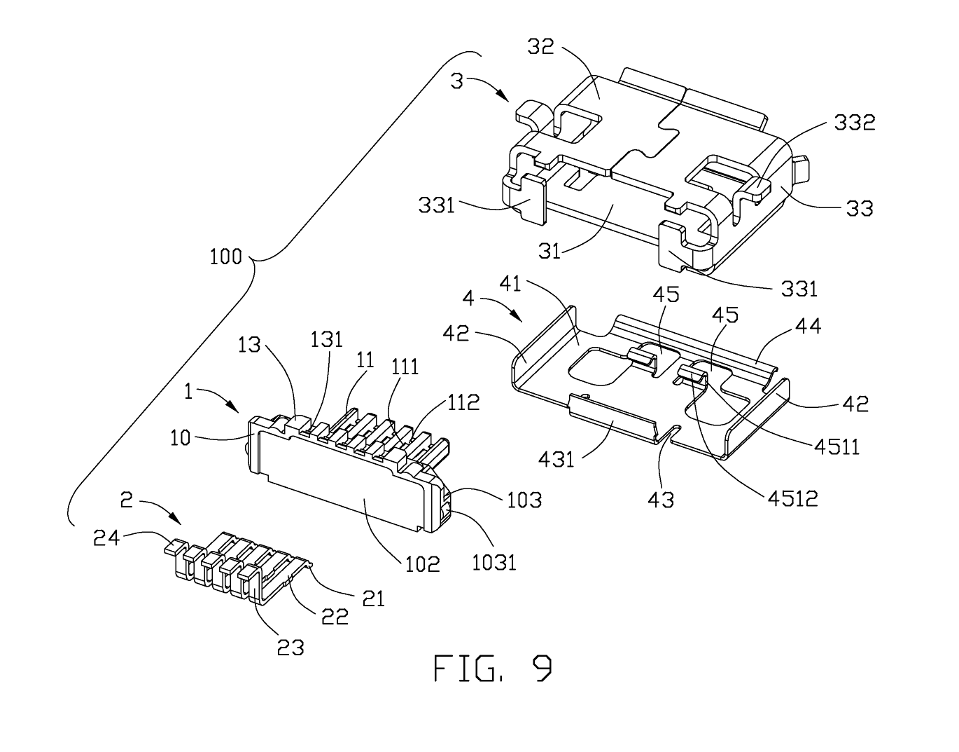

Referring to FIGS. 8-9, the insulative housing 1 includes a base portion 10 and a tongue 11 extending forwardly from the base portion 10. The base portion 10 is disposed as a rectangular shape. The base portion 10 includes a front wall 101, a rear wall 102 opposite to the front wall 101 and two side walls 103. The base portion 10 has a projection 12 extending upwardly from a top surface thereof and an extending portion 13 extending downwardly from a bottom surface thereof. The projection 12 extends upwardly beyond the base portion 10 and the extending portion 13 extends downwardly beyond the base portion 10. The projection 12 has a retaining groove 121 extending along a transversal direction. The extending portion 13 has a plurality of retaining grooves 131 passing therethrough along a front-to-rear direction and a bottom direction. The side walls 103 each have a convex 1031 extending outwardly therefrom. The tongue 11 has a plurality of grooves 111 depressed upwardly from a bottom surface thereof and passing forwardly therethrough and a plurality of mounting holes 112 depressed downwardly from a front of the grooves 111.

The contacts 2 are used for electrically connecting with the mating connector 200. The contacts 2 each include a contacting portion 22 received in the groove 111 of the tongue 11, a retaining portion 21 extending downwardly from the contacting portion 22 and being assembled in the mounting hole 112, a connecting portion 23 extending downwardly and vertically from the contacting portion 22 and a soldering portion 24 extending backwardly and horizontally from the connecting portion 23. The connecting portion 23 abuts against the front wall 101 of the base portion 10 backwardly. The soldering portion 24 extends out of the base portion 10 backwardly through the retaining groove 131.

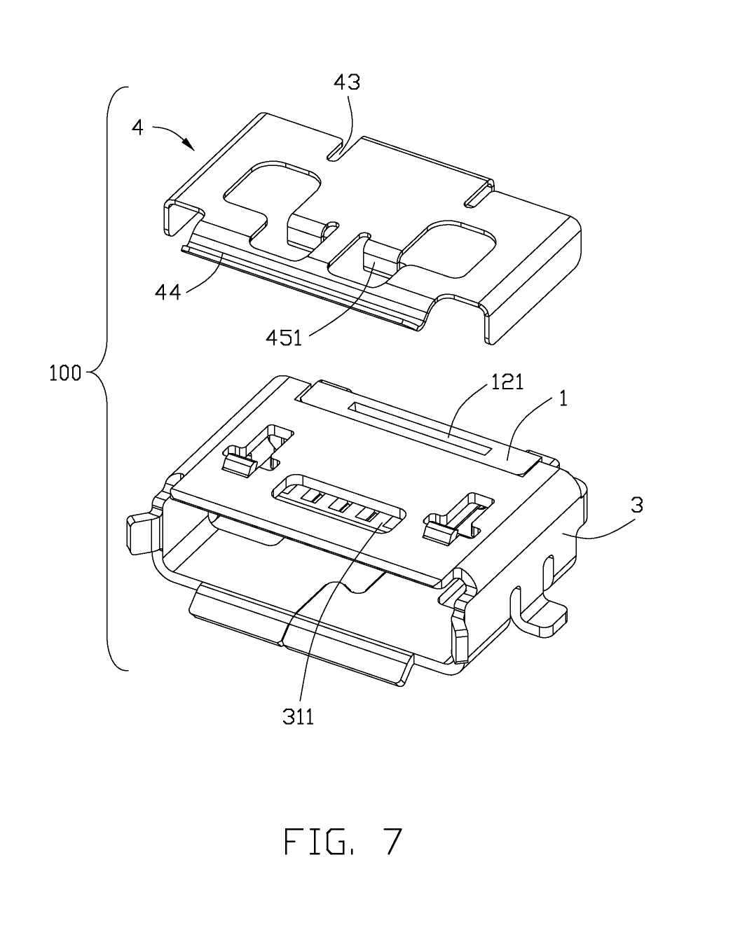

Referring to FIGS. 7-9, the metal shell 3 encloses the insulative housing 1 and surrounds the tongue 11 to form a mating opening 110 between the metal shell 3 and the tongue 11 for receiving the mating connector 200. The metal shell 3 include a top wall 31, a bottom wall 32 and two side walls 33 connecting the top wall 31 and the bottom wall 32 together. The top wall 31 has a through hole 311 passing therethrough and extending along the transversal direction, a pair of locking holes 312 located at two sides of the through hole 311, a cutout 313 forwardly recessed from a rear edge of the top wall 31 and a pair of flanges 315 extending upwardly thereof and located in a front of the locking holes 312. The through hole 311 is located near a front edge of the top wall 31. The cutout 313 engages with the projection 12 of the insulative housing 1 to prevent the metal shell 3 from moving backwardly. The projection 12 is in a same height as that of the top wall 31.

Each side wall 33 has a locking strip 331 inwardly bent from a rear end of the side walls 33, and a mounting leg 332 downwardly extending from the side wall 33. The locking strip 331 abuts against the rear wall 102 of the base portion 10 for preventing the metal shell 3 from moving forwardly.

The mounting plate 4 is made by metallic material. The mounting plate 4 includes a horizontal pressing plate 41, two extending plates 42 extending downwardly from two opposite sides of the pressing plate 41, a pair of notches 43 defined on a rear edge of the pressing plate 41, a V-shaped front nose portion 44 extending forwardly from a front edge of the pressing plate 41 and two openings 45 passing through the pressing plate 41. The mounting plate 4 further includes a vertical tab 431 extending downwardly from the rear edge of the pressing plate 41 and located between the notches 43 and two pressing arms or abutment sections 451 extending downwardly from an inside edge of the openings 45. The pressing arm 451 includes a vertical part 4511 and a free end 4512 extending horizontally and backwardly from the vertical part 4511. The flanges 315 pass through the opening 45 and one inside edge of the opening 45 resists the flange 315 backwardly to prevent the mounting plate 4 from moving backwardly.

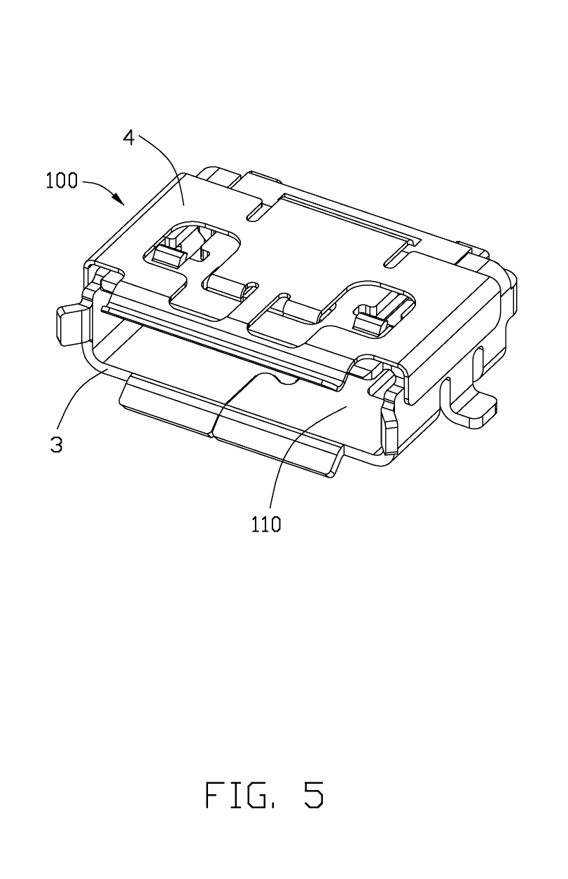

In FIGS. 4-5, when the mounting plate 4 is assembled to the metal shell 3, the pressing plate 4 covers upon the top wall 31 of the metal shell 3. The tab 431 downwardly inserts into the retaining groove 121 of the insulative housing 1 and the extending plates 42 resist on the side walls 33 of the metal shell 3. The pressing arms 451 pass through the through hole 311 and extend into the mating opening 110 conjoined with FIG. 7. The pressing arms 451 are located in the front of the tongue 11. The nose portion 44 is lower than the top wall 31 of the metal shell 3 and is located in the front of the mating opening 110. The tab 431 interferes with the retaining groove 121 to fasten the mounting plate 4 to the insulative housing 1, and the pressing plate 41 is able to deflect upwardly around the tab 431 which is regarded as a fixed end, by an elasticity of the mounting plate 4 itself, that also make the pressing plate 41 restore.

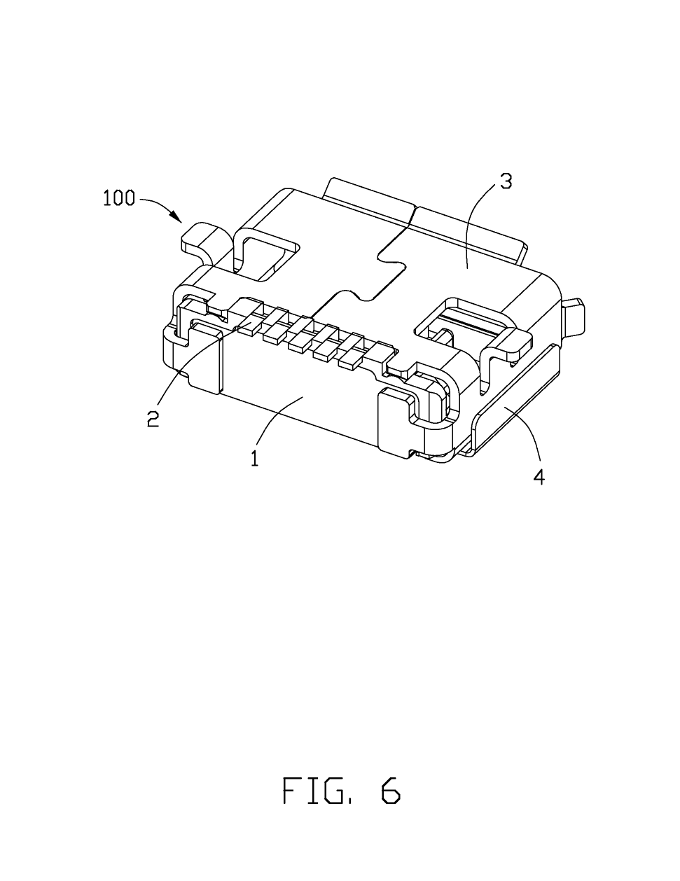

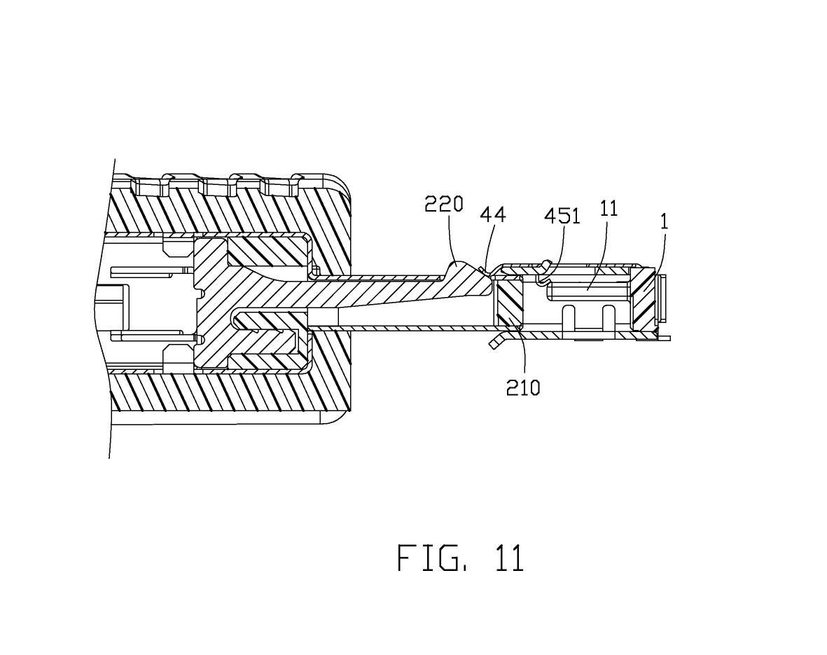

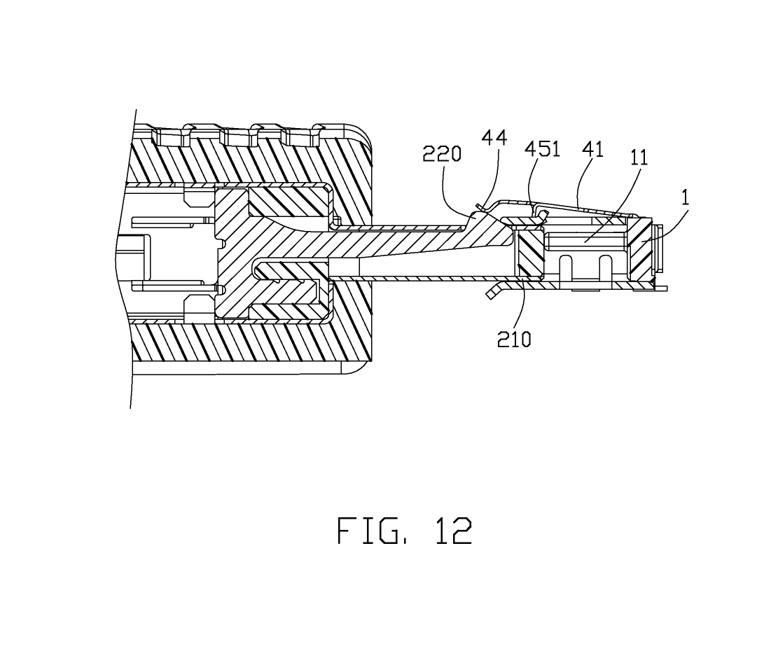

In FIGS. 11-12, a mating status of the electrical connector 100 with the mating connector 200 is shown. The mating connector 200 includes a mating portion 210 and a pair of locking contacts 220 extending upwardly out of the mating portion 210. The locking holes 312 are used to lock with the locking contacts 220 of the mating connector 200. Referring to FIGS. 6-8, When the mating connector 200 inserts into the electrical connector 100 in a right direction, the locking contacts 220 contact with the nose portion 44 firstly as shown in FIG. 7, and then the locking contacts 220 push the nose portion 44 to move upwardly, the pressing plate 41 deflects upwardly and brings the pressing arms 451 to move upwardly and leave the mating opening 110. Finally, the mating portion 210 inserts into the mating opening 110 fully as shown in FIG. 8. When the mating connector 200 is ejected from the electrical 100, the pressing plate 41 recovers the top wall 31 of the metal shell 3, the pressing arms 451 return into the mating opening 110 and are located in the front of the tongue 11.

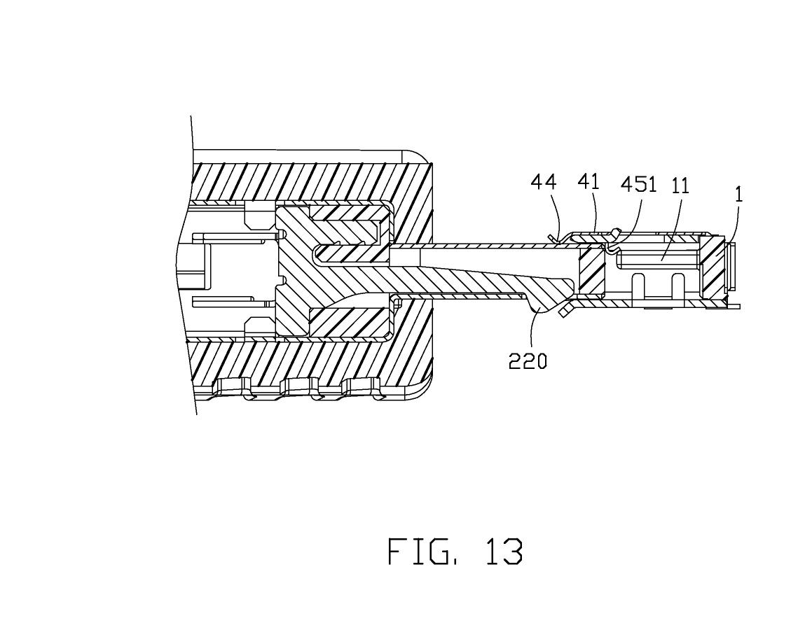

In FIG. 13, when the mating connector 200 is inserted into the electrical connector 100 in a wrong direction. The mating portion 210 of the mating connector 200 is inserted into the mating opening 110 of the electrical connector 100, the pressing arm 451 is kept in the front of the tongue 11. Then, the mating portion 200 abuts against the pressing arm 451 and is prevented from inserting into the electrical connector 100 further.

The electrical connector 100 has a mounting plate 4, the mounting plate 4 has a pair of pressing arms 451 extending downwardly into the mating opening 110 and a nose portion 44 extending forwardly beyond the mating opening 110. The mating connector 200 inserts into the mating opening 110 correctly and pushes the pressing arm 451 upwardly by the locking contacts 220 firstly to remove the pressing arm 451, when the mating connector 200 is inserted wrongly, the pressing arm 451 stays in the mating opening 110 and prevent the mating connector 200 from further inserting.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, adapted for mating with a mating connector, comprising:
an insulative housing having a base portion and a tongue extending forwardly from the base portion;
a plurality of contacts retained in the insulative housing;
a metal shell enclosing the insulative housing to form a mating opening, the insulative housing assembled to the metal shell along a rear-to-front direction; and
a mounting plate assembled to the metal shell and having a pressing plate covering a top of the metal shell, the mounting plate having at least one pressing arm extending downwardly from the pressing plate into the mating opening and a nose portion extending forwardly from a front edge of the pressing plate and located in a front of the pressing arm, the nose portion being pushed upwardly and bringing the pressing plate with the pressing arm to move out of the mating opening.

2. The electrical connector as claimed in claim 1, wherein the base portion of the insulative housing has a retaining groove near a rear edge of a top surface thereof, the mounting plate has a tab inserted into and interfering with the retaining groove to retain the mounting plate.

3. The electrical connector as claimed in claim 1, wherein the pressing plate defines an opening, the at least one pressing arm extends from a rear edge of the opening.

4. The electrical connector as claimed in claim 2, wherein the tab extends backwardly from a rear edge of the pressing plate and located between two notches defined on the rear edge.

5. The electrical connector as claimed in claim 1, wherein the pressing arm includes a vertical part linking with the pressing plate and a back plate extending horizontally and backwardly from the vertical part.

6. The electrical connector as claimed in claim 2, wherein the metal shell comprises a top wall, a bottom wall and two side walls connecting with the top wall and the bottom wall together, the metal shell defines a through hole on the top wall, the tab passes through the metal shell and into the retaining groove, the mounting plate has two extending plates extending downwardly from two sides of the pressing plate and resisting the two side walls of the metal shell.

7. The electrical connector as claimed in claim 6, wherein when the nose portion is upwardly forced, the pressing plate deflects upwardly while the tab is kept being fastened in the retaining groove.

8. The electrical connector as claimed in claim 1, wherein the base portion has a projection extending upwardly from a top surface thereof and abutting against the metal shell forwardly, the retaining groove is depressed downwardly from the projection, the projector is coplanar with a top wall of the metal shell.

9. The electrical connector as claimed in claim 1, wherein the tongue has a plurality of grooves depressed upwardly from a bottom surface thereof and a plurality of mounting holes depressed downwardly from a front of the grooves, the contacts each have a contacting portion received in the groove of the tongue, a retaining portion extending downwardly from the contacting portion and assembled in the mounting hole, a connecting portion extending downwardly and vertically from the contacting portion and a soldering portion extending backwardly and horizontally from the connecting portion.

10. The electrical connector as claimed in claim 3, wherein the top wall of the metal shell has a flange extending upwardly thereof, the flange passes through the opening of the mounting plate and an inner edge of the opening resists the flange backwardly.

11. An electrical connector, comprising:
an insulative housing having a base portion and a tongue extending forwardly from the base portion;
a plurality of contacts retained in the insulative housing;
a metal shell enclosing the insulative housing to form a mating opening, and
a mounting plate retained in the insulative housing and having a pressing plate covering the metal shell, the pressing plate having at least one pressing arm extending downwardly therefrom and into the mating opening and a tab extending downwardly from a rear edge thereof and fasten to the insulative housing, the pressing plate being able to deflect upwardly around the tab and bringing the pressing arm to move out of the mating opening.

12. The electrical connector as claimed in claim 11, wherein the base portion has a retaining groove, the tab is inserted into the retaining groove and interfering with the retaining groove, when the mounting plate deflects upwardly, the tab is kept in unmovable state.

13. The electrical connector as claimed in claim 11, wherein the pressing plate has a nose portion extending forwardly from a front edge of the pressing plate and located in a front of the pressing arm, the nose portion is pushed upwardly and brings the pressing plate with the pressing arm to move out of the mating opening.

14. The electrical connector as claimed in claim 13, wherein the mounting plate has two extending plates extending downwardly from two opposite sides of the pressing plate, the metal shell has a top wall and two side walls bent from the top wall, the extending plates resist two side walls of the metal shell.

15. The electrical connector as claimed in claim 14, wherein the pressing plate defines two openings, the pressing arm extends from a rear edge of the opening, the top wall of the metal shell has at least one flange extending upwardly thereof, the flange passes through the opening of the mounting plate and an inner edge of the opening resists the flange backwardly.

16. An electrical connector for use with a plug having a deflectable latch thereof, comprising:
an insulative housing defining a base portion and a tongue portion extending forwardly from the base portion;
a plurality of contacts disposed in the housing with contacting sections exposed upon the tongue portion;
a metallic shell assembled to the housing and cooperating with the tongue portion to define a mating port; and
a deflectable mounting plate associate with at least one of said housing and said shell and including, in a front-to-back direction, a front nose portion around a front opening of the mating port, a and a rear abutment section extending into an interior of the mating port; wherein
said front nose portion is configured and located for confronting the latch to be outwardly deflected and successively have the abutment section leave from the mating port for having a front edge of the plug not stopped by the abutment section when the plug is correctly inserted into the mating port, and for not confronting the latch so as not to have the abutment section leave from the mating port but stopping the front edge of the plug for further insertion when the plug is upside down incorrectly inserted into the mating port; wherein
the front nose portion is spaced from the abutment section with a distance to allow the nose portion confronts the latch before the abutment section confronts the front edge of the plug when the plug is correctly inserted into the mating port.

17. The electrical connector as claimed in claim 16, wherein the mounting plate is discrete from and softer than the shell.

18. The electrical connector as claimed in claim 16, wherein the mating port is equipped with a pair of flared structures of which, one is formed by the shell and the other is formed by the nose portion.

19. The electrical connector as claimed in claim 16, wherein said mounting plate is essentially located outside of the shell.

20. The electrical connector as claimed in claim 16, wherein the latch of the plug is configured with forward and rearward tapered structures on front and rear region for automatic deflection of the latch during insertion and withdrawal of the plug with regard to the connector without assistance of manual deflecting the latch.
